(19) United States
(12) Patent Application Publication
(10) Pub. No.: US 2010/0255359 A1
(43) Pub. Date: Oct. 7, 2010

(54) BATTERY PACK AND BATTERY-EQUIPPED DEVICE

(76) Inventors: Yasushi Hirakawa, Osaka (JP); Hajime Nishino, Nara (JP); Tomohiko Yokoyama, Osaka (JP)

Correspondence Address: MCDERMOTT WILL & EMERY LLP, 600 13TH STREET, NW, WASHINGTON, DC, 20005-3096, US

(21) Appl. No.: 12/740,083

(22) PCT Filed: Oct. 24, 2008
(86) PCT No.: PCT/JP2008/003031

§ 371 Date: Apr. 27, 2010

(30) Foreign Application Priority Data
Oct. 29, 2007 (JP) 2007-28/0172
Oct. 14, 2008 (JP) 2008-264978

(51) Int. Cl. H01M 10/50

(52) U.S. Cl. 429/120

(57) ABSTRACT

The invention provides a battery pack and a battery-equipped device in which, even if a battery experiences an abnormal event to cause thermal runaway, and generates heat, temperature increase in the battery pack and batteries except for the battery which experienced the abnormal event can be prevented. For this purpose, a heat absorbing member 4 is arranged in space inside a battery pack 1 between a casing 2 and batteries 3. Even if one of the batteries 3 experiences thermal runaway, the heat absorbing member 4 absorbs heat generated by the battery 3, thereby preventing the thermal runaway from occurring in the other batteries 3.

### TECHNICAL FIELD

The present invention relates to battery packs and battery-equipped devices, particularly to battery packs including a plurality of cells, which are lithium ion batteries, and battery-equipped devices.

### BACKGROUND ART

High safety batteries and battery packs which offer high capacity, high voltage, and high power have been demanded in accordance with recent increase of the variety of electronic devices. In particular, for the purpose of providing the high safety batteries and battery packs, there has been a known technology of providing the batteries and the battery packs with various types of protectors, such as a positive temperature coefficient (PTC) device and a thermal fuse for preventing temperature increase, a protective circuit which senses an internal pressure in the battery to interrupt the current, etc. There has been another known technology of providing the battery pack with a control circuit for controlling charge/discharge of the battery so as not to cause an abnormal event (e.g., thermal runaway) in the battery.

However, even if the protector or the control circuit is provided, the battery temperature may increase, or high-temperature flammable gas may blow out of the battery when the battery is left in an abnormal condition. In this case, a casing of the battery pack containing the batteries may be broken, molten, or overheated, or the blown flammable gas may leak out of the battery pack.

Countermeasures against this phenomenon have been proposed. According to a proposed method, the gas emitted from the battery is diffused in a casing of the battery pack containing a plurality of batteries while reducing the temperature and pressure of the gas, and then the gas is emitted out of the casing (see e.g., Patent Document 1). According to another proposed method, a bag which can expand in the shape of a duct is attached to a group of connected cells each having a safety valve for emitting the gas when a pressure inside the cell reaches a predetermined value or higher. The bag expands in the shape of a duct when a large amount of gas is generated, and then the gas emitted by the cell is discharged outside to reduce a pressure of the discharged gas (see Patent Document 2).

### Patent Documents

Patent Document 1: Japanese Patent Publication No. 2005-322434

Patent Document 2: Japanese Patent Publication No. 2005-339932

### SUMMARY OF THE INVENTION

### Technical Problem

In an abnormal situation where the gas is emitted out of the battery, temperatures of the surface of the battery and the released gas may considerably increase even if the technologies described in Patent Documents 1 and 2 are employed. Due to the heat generated by the battery and the gas, temperatures of adjacent batteries sequentially increase. This may cause an abnormal event in every battery in the battery pack, or may melt the casing of the battery pack by the heat. Further, since the emitted gas is flammable, the temperature may further increase.

In view of the foregoing, the present invention has been achieved. An object of the invention is to provide a battery pack and a battery-equipped device in which, even if a battery experiences an abnormal event to cause thermal runaway, and generates heat, temperature increase in the battery pack and batteries except for the battery which experienced the thermal runaway can be prevented.

### Solution to the Problem

A battery pack of the present invention includes: a plurality of cells; a casing for containing the cells; and a heat absorber for absorbing heat generated by the cells, wherein the cells are lithium ion batteries, and the heat absorber absorbs heat of gas generated from the inside of one of the cells which experienced thermal runaway so as to keep temperature of the gas at 300° C. or lower, thereby preventing the thermal runaway from occurring in the other cells adjacent to the cell which experienced the thermal runaway. In this context, the thermal runaway is a situation where the temperature in the cell increases to 200° C. or higher, and a chemical reaction proceeds in the battery, thereby accelerating temperature increase in the battery. In this case, a positive electrode active material and a negative electrode active material in the cell are thermally decomposed to generate high-temperature flammable gas. Further, if external heat is applied to the adjacent other cells, a separator may be molten, or the structure of an active material may physically and chemically change, thereby causing the thermal runaway. Therefore, to prevent the thermal runaway in the adjacent other cells is to alleviate heat transfer to the other cells in such a manner that an amount of heat applied to the other cells is kept smaller than the amount of heat which melts the separator, or changes the structure of the active material.

With this configuration, the heat absorber absorbs the heat generated by the battery. This can prevent the thermal runaway from occurring in a chain reaction, and can alleviate thermal damage to the casing. The heat absorber preferably contains a material which experiences at least one of physical and chemical changes, such as melting and vaporization, due to the heat generated by the battery. The heat absorber may contain a material which can quickly transfer and emit the heat out of the battery pack without experiencing any physical and chemical changes.

The casing may be made of a material having a specific heat of 0.5 J/g·K or higher.

The heat absorber may be placed inside the casing. In this case, the heat absorber preferably fills almost the whole space between the casing and the cells. The heat absorber may be in a solid, liquid, or vapor state. The heat absorber in a solid state is easy to handle, thereby allowing for easy assembly of the battery pack. The heat absorber in a liquid state can easily fill the space between the casing and the cells even if the shape of the space is complicated. The heat absorber in a vapor state can easily reduce the weight of the battery pack.

The heat absorber may be made of a material having a specific heat of 0.5 J/g·K or higher.

Further, the battery pack preferably includes: an exhaust path for guiding the gas outside the casing, wherein the gas is preferably emitted through an emission hole provided in the cell. With this configuration, the gas emitted from the inside of the cell is emitted outside the battery pack without contacting the other cells in the battery pack. This can reduce the risk of causing an abnormal event in the other cells in the battery pack. Further, the exhaust path can cool the gas.

A first battery-equipped device of the present invention includes the above-described battery pack. This configuration can prevent damage to the battery-equipped device due to the heat generated by the battery.

A second battery-equipped device of the present invention includes: a plurality of cells; a containing chamber for containing the cells; and a heat absorber for absorbing heat generated by the cells, wherein the cells are lithium ion batteries, and the heat absorber absorbs heat of gas generated from the inside of one of the cells which experienced thermal runaway so as to keep temperature of the gas at 300° C. or lower, thereby preventing the thermal runaway from occurring in the other cells adjacent to the cell which experienced the thermal runaway. This configuration can prevent damage to the battery-equipped device due to the heat generated by the battery.

The battery-equipped device further includes: an exhaust path for guiding the gas outside the casing, wherein the gas is emitted through an emission hole provided in the cell.

### ADVANTAGES OF THE INVENTION

In the battery pack and the battery-equipped device of the present invention, the heat absorber absorbs the heat generated by the battery. This can prevent the them al runaway from occurring in a chain reaction, thereby preventing damage to the battery pack, and damage to the battery-equipped device due to the heat generated by the battery.

### BRIEF DESCRIPTION OF THE DRAWINGS

FIG. 1 is a perspective view illustrating the structure of a battery pack of a first embodiment.

FIG. 2 is a cross-sectional view of the battery pack of the first embodiment.

FIG. 3 is a schematic cross-sectional view illustrating the inner structure of a battery of the first embodiment.

FIG. 4 is a schematic view illustrating a battery assembly of the first embodiment.

FIG. 5(a) is a cross-sectional view of a battery pack of a third embodiment, and FIG. 5(b) is a top view of the battery pack from which a lid is removed.

FIG. 6 is a diagram illustrating a battery pack of another embodiment.

FIG. 7 is a cross-sectional view of a battery pack of a second embodiment.

FIG. 8 is a cross-sectional view of a battery pack of a fourth embodiment.

FIG. 9 is a view illustrating the position at which a nail is inserted for a nail penetration test, and the position at which temperature is measured.

FIG. 10 is a cross-sectional view of a battery-equipped device of a fifth embodiment.

FIG. 11 is a perspective view illustrating the general structure of a notebook computer equipped with a battery pack.

FIG. 12 is a perspective view of the battery pack of FIG. 11 in a disassembled state.

FIG. 13 is a cross-sectional view taken along the line XIII-XIII in FIG. 11.

FIG. 14 is a cross-sectional view taken along the line XIV-XIV in FIG. 13.

FIG. 15 is a side view illustrating the general structure of an electric bicycle equipped with a battery pack.

FIG. 16 is a perspective view illustrating the battery pack of FIG. 15 in a disassembled state.

FIG. 17 is a cross-sectional view taken along the line XVII-XVII in FIG. 16.

FIG. 18 is a side view of a hybrid automobile equipped with a battery pack.

FIG. 19 is a perspective view of the battery pack of FIG. 18 in a disassembled state.

FIG. 20 is a cross-sectional view taken along the line XX-XX in FIG. 19.

### DESCRIPTION OF EMBODIMENTS

Embodiments of the present invention will be described below in detail with reference to the drawings. In the following drawings, components of substantially the same functions are designated by the same reference characters for easy description.

### First Embodiment

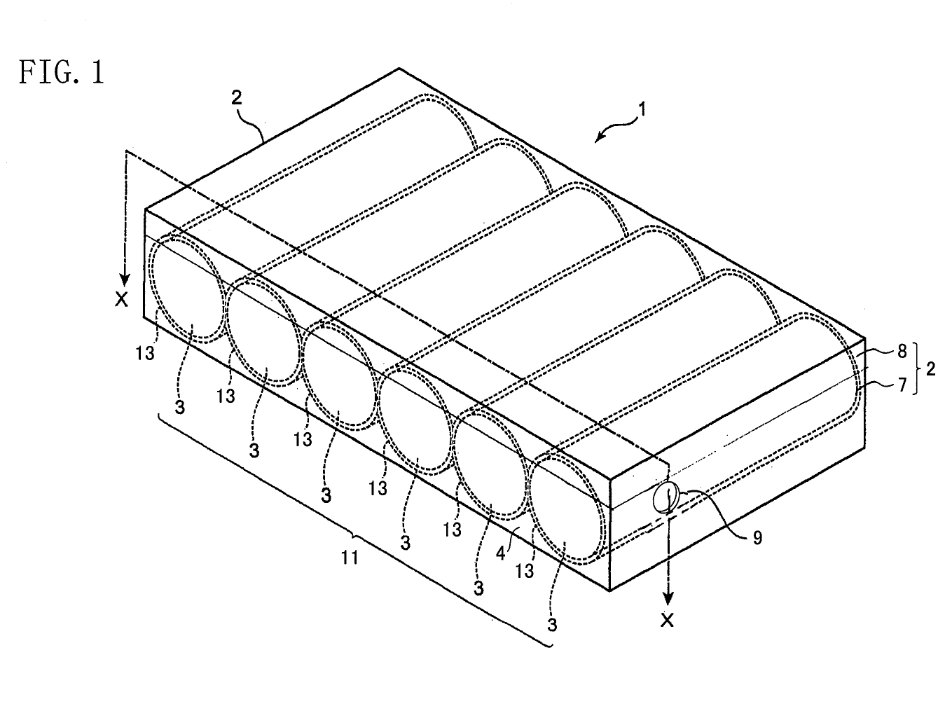

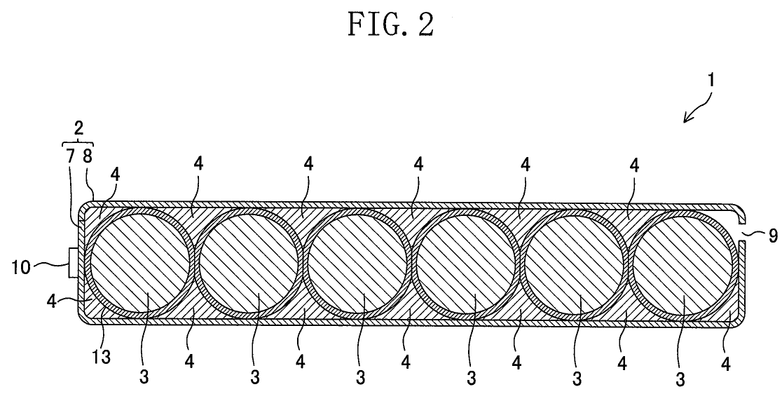

FIG. 1 is a perspective view illustrating the structure of a battery pack 1 of a first embodiment. FIG. 2 is a cross-sectional view of the battery pack 1 taken along the line X-X in FIG. 1. A battery-equipped device according to the present embodiment is equipped with, and is powered by the battery pack 1 shown in FIG. 1, and includes, for example, electronic devices such as portable personal computers and video cameras, vehicles such as four-wheel vehicles and two-wheel vehicles, electric tools, etc. When the battery-equipped device is a vehicle, the battery pack 1 may be used, for example, as a power source for electrical components mounted on the vehicle, or a power source for driving electric automobiles, hybrid cars, etc.

The battery pack 1 shown in FIG. 1 contains a battery assembly 11 including a plurality of connected cylindrical batteries 3 (cells) in a casing 2 substantially in the shape of a rectangular parallelepiped box. A sheet-like battery case insulator 13 is wound around each of the batteries 3, thereby insulating the adjacent batteries 3, 3. The casing 2 includes a battery container 7 and a battery pack lid 8. The battery container 7 is provided with an opening 9 (an emission hole) through which gas emitted from the battery 3 is emitted out of the battery pack 1.

A heat absorbing member 4 (a heat absorber) is attached to an inner wall of the casing 2, i.e., on inner walls of the battery container 7 and the battery pack lid 8, to fill space between the casing 2 and the battery assembly 11. A battery pack terminal 10 for drawing electricity from the battery assembly 11 is attached to an outer wall of the battery container 7. The battery container 7 and the battery pack lid 8 are made of, for example, metal as a nonflammable material such as iron, nickel, aluminum, titanium, copper, stainless steel, etc., heat-resistant resin such as wholly aromatic liquid crystalline polyester, polyether sulphone, aromatic polyamide, etc., or a stack of metal and resin. With the battery container 7 covered and closed with the battery pack lid 8, the substantially rectangular parallelepiped box-shaped casing 2 is provided.

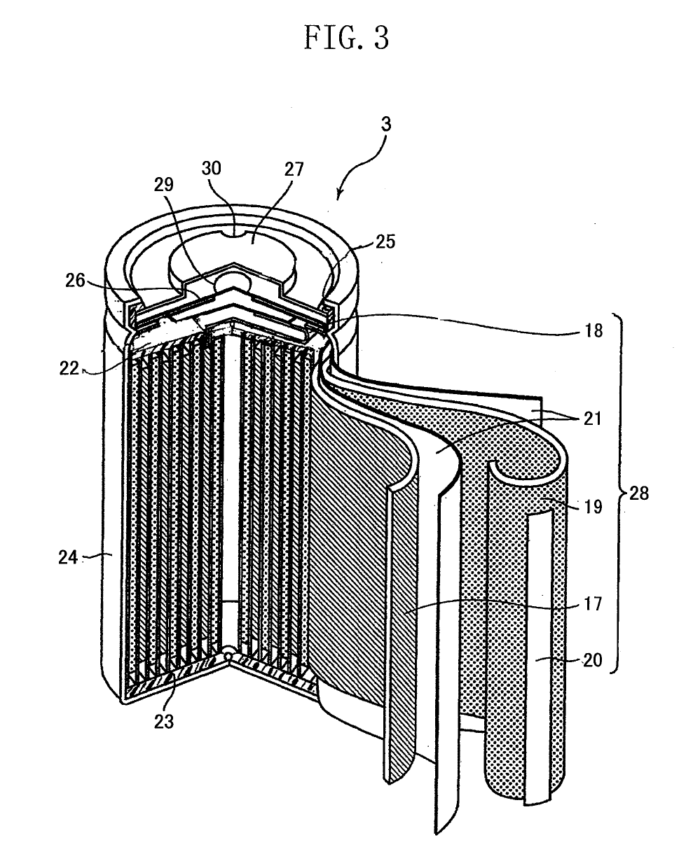

FIG. 3 is a schematic cross-sectional view illustrating the structure of the battery 3. The battery shown in FIG. 3 is a non-aqueous electrolyte secondary battery including a wounded electrode group 28, e.g., a cylindrical, 18650-size lithium ion secondary battery. The electrode group 28 includes a positive electrode 17 having a positive current collector lead 18, and a negative electrode 19 having a negative current collector lead 20 which are wound into a spiral form with a separator 21 interposed therebetween. An upper insulator 22 is attached to an upper end of the electrode group 28, and a lower insulator 23 is attached to a lower end of the electrode group 28. A case 24 containing the electrode group 28 and a nonaqueous electrolyte (not shown) is sealed with a gasket 25, a sealing plate 26, and a positive electrode terminal 27.

The positive electrode 17 shown in FIG. 3 includes a positive electrode active material substantially uniformly applied to a surface of a positive electrode current collector made of metal foil, e.g., aluminum foil, etc. The positive electrode active material contains transition metal-containing composite oxide containing lithium, e.g., transition metal-containing composite oxide such as LiCoO₂, LiNiO₂, etc., used in nonaqueous electrolyte secondary batteries. Among the transition metal-containing composite oxides, transition metal-containing composite oxide is preferable which is resistant to high charge end voltage, and in which Co is partially substituted with a different element, and an additive is adsorbed or decomposed to form a high quality coating on the surface of the transition metal-containing composite oxide in a high voltage state. Examples of the transition metal-containing composite oxide include, for example, transition metal-containing composite oxide represented by the general formula LiₐM_{b}Ni_{c}Co_{d}Oₑ (where M is at least one metal selected from the group consisting of Al, Mn, Sn, In, Fe, Cu, Mg, Ti, Zn, and Mo, 0<a<1.3, 0.02≦b≦0.5, 0.02≦d/c+d≦0.9, 1.8<e<2.2, b+c+d=1, and 0.34<c). In particular, in the general formula, M is preferably at least one metal selected from the group consisting of Cu and Fe.

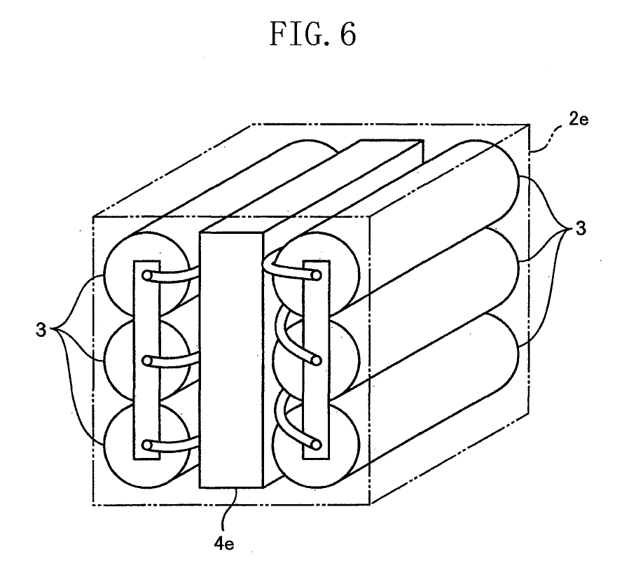

The negative electrode 19 shown in FIG. 6 includes a negative electrode active material substantially uniformly applied to a surface of a negative electrode current collector made of metal foil, e.g., copper foil, etc.

Examples of the negative electrode active material include materials capable of reversibly inserting and extracting lithium, such as carbon materials, lithium-containing composite oxides, materials capable of alloying with lithium, and lithium metal. The carbon materials include, for example, coke, pyrocarbons, natural graphite, artificial graphite, mesocarbon microbeads, graphitized mesophase microspheres, vapor grown carbon, glassy carbons, carbon fibers (polyacrylonitrile-based carbon fiber, pitch-based carbon fiber, cellulose-based carbon fiber, and vapor grown carbon fiber), amorphous carbon, carbon from a baked organic substance, etc. They may be used alone, or in combination with two or more materials. Among them, a carbon material obtained by graphitizing mesophase microspheres, and graphite materials, such as natural graphite, artificial graphite, etc., are preferable. The material capable of alloying with lithium may be, for example, Si, a compound of Si and O (SiOₓ), etc. They may be used alone, or in combination with two or more materials. Use of the silicon-based negative electrode active material makes it possible to provide a higher capacity nonaqueous electrolyte secondary battery.

A substantially round groove 29 is formed substantially at the center of the sealing plate 26. When gas is generated in the case 24, and the internal pressure exceeds a predetermined pressure, the groove 29 is broken, thereby emitting the gas in the case 24 outside. A protrusion for external connection is provided substantially at the center of the positive electrode terminal 27, and an electrode opening 30 (an emission hole) is formed in the protrusion. The gas emitted through the broken groove 29 is emitted outside the battery 3 through the electrode opening 30.

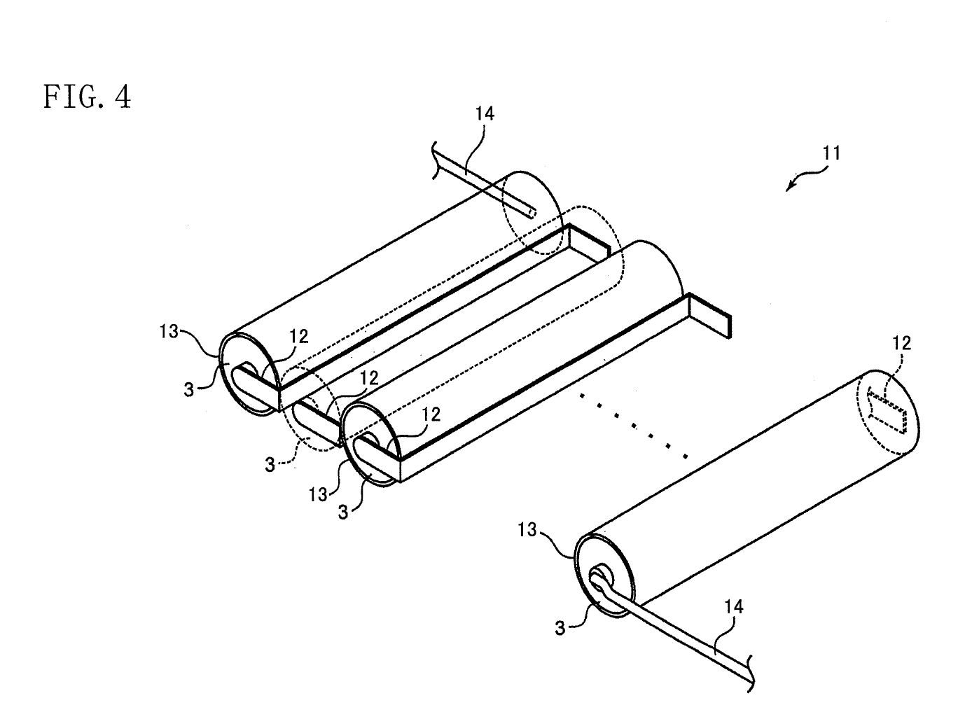

FIG. 4 shows the schematic structure of the battery assembly 11. The battery assembly 11 shown in FIG. 4 includes six batteries 3 connected in series through connector plates 12. The connector plates 12 and the batteries 3 are connected by welding, for example. A sheet-like battery case insulator 13 is wound around each of the batteries 3. Ends of a series circuit of the six batteries 3 are connected to two battery pack terminals 10 through connector lead wires 14, respectively.

As shown in FIG. 3, the electrode group 28 is wound into a spiral form to provide the battery 3. This can easily make the battery compact, while increasing an area of the electrode. Therefore, the battery 3 is generally provided by winding the electrode group 28 into a spiral form. The battery 3 provided by winding the electrode group 28 into a spiral form is inevitably cylindrical.

The battery pack 1 is contained in a casing of the battery-equipped device, or is attached to an outer wall of the battery-equipped device. Therefore, the casing 2 of the battery pack 1 is generally in the shape of a square box to be easily contained in, or attached to the casing of the battery-equipped device. Accordingly, the batteries 3 are cylindrical, while the casing 2 is square-shaped. Even when the cylindrical batteries 3 are contained as many as possible in the square casing 2, large empty space is left in the casing 2 where the batteries 3 do not exist due to the difference between the shapes of the batteries 3 and the casing 2. The empty space can be filled with the heat absorbing member 4 as the heat absorber. Thus, in the battery pack 1 of the present embodiment, the heat absorbing member 4 for absorbing heat generated by the batteries is provided between the inner wall of the casing 2 and the batteries 3 so as to absorb the heat generated by the battery 3, and heat of gas emitted through the electrode opening 30 of the battery 3, thereby particularly keeping the gas temperature at 300° C. or lower. In the casing 2 of the battery pack 1, the gas flows through an exhaust path, which is space around the positive electrode terminal 27 of each battery 3, and is emitted outside the battery pack 1 through the opening 9.

The gas generated from the inside of the battery 3 in the event of thermal runaway includes several types of flammable gases generated from the positive electrode active material, the negative electrode active material, and the electrolyte. The gas may spontaneously be ignited when its temperature exceeds 300° C. In the present embodiment, however, the heat absorbing member 4 absorbs the heat to keep the gas temperature at 300° C. or lower, and the gas is emitted outside the battery pack 1 through the electrode opening 30. When the temperature in the battery 3 is 200° C. or higher, the separator is molten, and an internal short circuit occurs. However, as long as the heat absorbing member 4 absorbs heat to keep the gas temperature at 300° C. or lower, and the gas is emitted outside the battery pack 1 through the electrode opening 30, the temperatures inside the adjacent batteries are kept lower than 200° C. at the maximum. Therefore, the internal short circuit does not occur.

With the battery pack 1 configured as described above, even if the battery 3 generates heat due to the internal short circuit or overcharge, and the thermal runaway occurs where the high temperature gas is emitted from the inside of the battery 3, the heat absorbing member 4 absorbs the heat generated by the battery 3. This can prevent thermal damage to the battery pack, and can prevent spontaneous ignition and combustion of the emitted gas. Thus, damage to the battery pack 1 can be prevented.

The heat absorbing member 4 may be made of any material as long as it can keep the temperature of the gas generated by the battery 3 due to the thermal runaway at 300° C. or lower, and can protect adjacent batteries 3 from the heat generated by the thermal runaway to prevent the thermal runaway from occurring in the adjacent batteries 3. For example, the heat absorbing member 4 may be made of metal such as aluminum, titanium, etc., a nonflammable solid substance such as ceramics, sand, etc., nonflammable liquid such as water, ionic liquids including imidazolium-based ionic liquid, pyridinium-based ionic liquid, aliphatic quaternary ammonium-based ionic liquid, etc., nonflammable gas such as argon, nitride, carbon dioxide, etc., or a high specific heat material having a specific heat of 0.5 J/g·K or higher, such as a nonflammable heat insulator called Heat Buster TK2 manufactured by PDM, and an agent for preventing fire spreading called Fire Barrier manufactured by Sumitomo 3M. For example, aluminum has a specific heat of 0.9 J/g·K, alumina has a specific heat of 0.6-0.8 J/g·K, and silicon carbide has a specific heat of 0.67 J/g·K. The Heat Buster TK2 is a gelled material containing a large amount of water, and absorbs heat by heat of evaporation of water. The Fire Barrier expands as it absorbs heat, thereby insulating heat through the expansion.

In the present embodiment, a solid material is attached to the inner wall of the casing 2 as the heat absorbing member 4. However, the heat absorbing member is not necessarily attached to the casing 2, but may be arranged near (around) the battery 3 in the casing 2, or may integrally be molded with the casing 2.

With use of the nonflammable material as the heat absorbing member 4, the heat generated by the battery 3 which experienced the thermal runaway due to the internal short circuit or overcharge in the battery 3, and the heat of the gas emitted from the battery 3 do not cause the thermal runaway in the other batteries 3, and do not burn the heat absorbing member 4. Thus, damage to the battery pack 1 is prevented.

### Second Embodiment

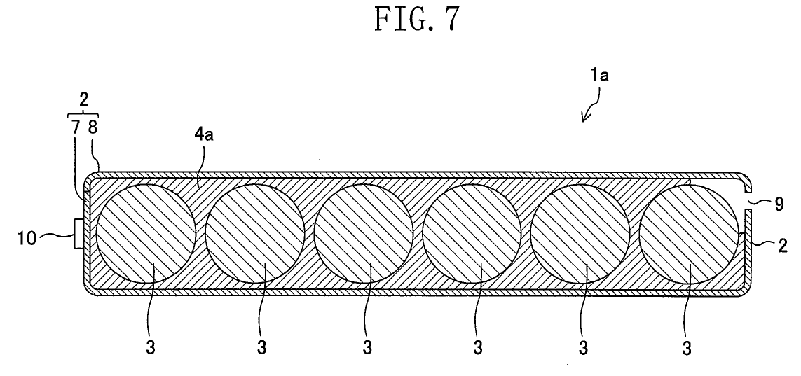

A battery pack 1a of a second embodiment includes, as shown in FIG. 7, a nonflammable, gelled heat absorbing member 4a directly filling space between the casing 2 and the battery 3. The heat absorbing member 4a has a specific heat of 0.5 J/g·K or higher, and the batteries 3 are covered only by filling the space with the heat absorbing member 4a. This allows for easy production of the battery pack 1a. The heat absorbing member 4a is not limited to the gelled material, and it may be liquid or gas. The same components as those of the first embodiment will not be described again.

The battery pack 1a of the present embodiment and the battery-equipped device using the battery pack 1a are easily manufactured, and offer the same advantages as those of the first embodiment.

### Third Embodiment

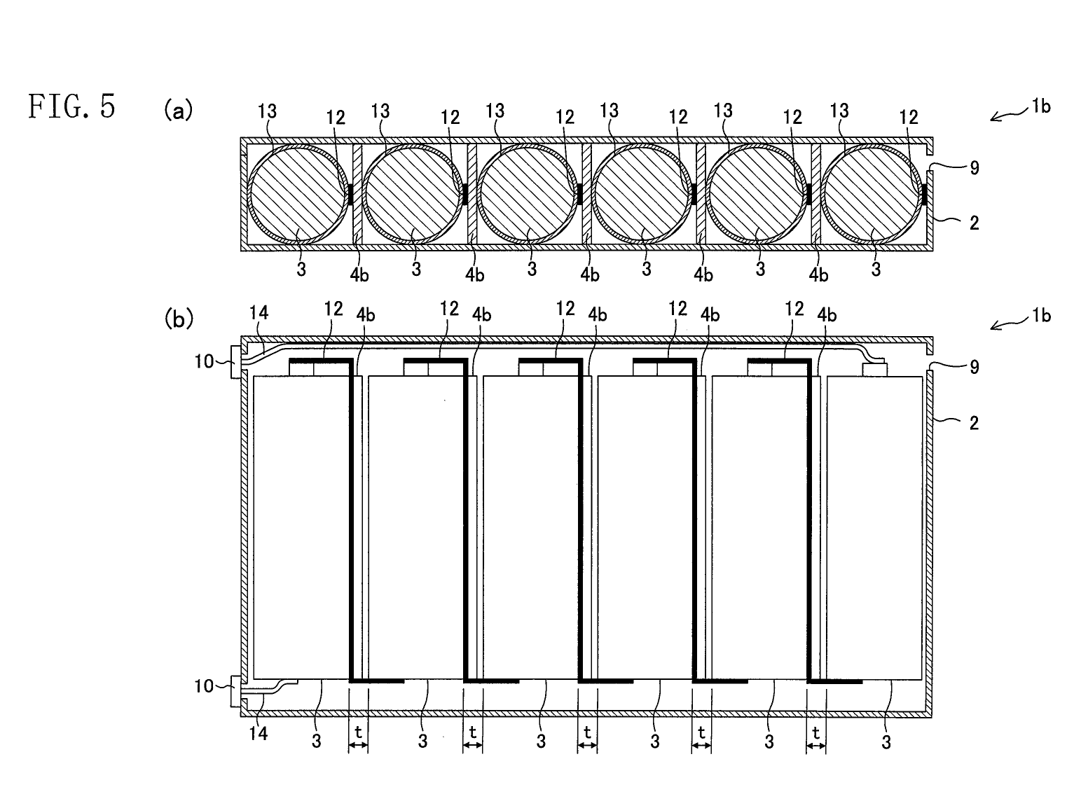

A battery pack 1b of a third embodiment includes, as shown in FIG. 5, six batteries 3 arranged in a substantially rectangular parallelepiped casing 2, and a heat absorbing member 4b (a heat absorber) in the shape of a flat plate is arranged between adjacent batteries 3, 3. The heat absorbing member 4b has a specific heat of 0.5 J/g·K or higher. An interval t is provided between two adjacent batteries 3, 3, and the thickness of the heat absorbing member 4b is smaller than t by the thickness of the connector plate 12 and a gap for packing the batteries 3 in the casing 2. The heat absorbing member 4b is in contact with the battery 3 through the battery case insulator 13, and is able to quickly absorb heat from the battery 3. The same components as those of the first and second embodiments will not be described again.

The battery pack 1b of the present embodiment is simply configured. The battery pack 1b and the battery-equipped device using the battery pack 1b offer the same advantages as those of the first embodiment.

### Fourth Embodiment

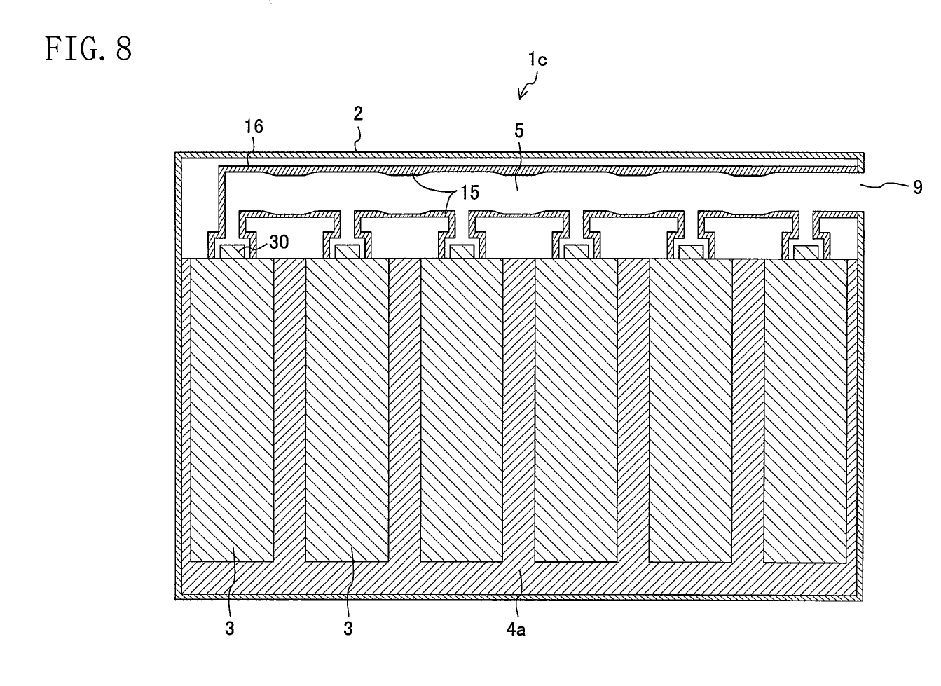

In a battery pack 1c of a fourth embodiment, as shown in FIG. 8, a gas collecting member 16 is attached to the sealed portions of the batteries 3 in the battery pack 1a of the second embodiment to cover the electrode openings 30 of the batteries 3, and an exhaust path 5 is provided in the casing 2 to connect the gas collecting member 16 and the opening 9. A cross-sectional area of the exhaust path 5 is determined by the capacity of the batteries 3 placed in the casing 2. As a guideline, the cross-sectional area is preferably 16 mm² or larger when the capacity of the batteries 3 is about 2 Ah, 40 mm² or larger when the capacity is about 5 Ah, and 80 mm² or larger when the capacity is about 10 Ah. Material of the exhaust path 5 is preferably metal such as copper, aluminum, stainless steel, etc., in view of heat absorbing property. In the present embodiment, a wall of the exhaust path 5 also functions as the heat absorbing member for absorbing heat of the gas. The exhaust path 5 is provided with protrusions 15 on an inner wall thereof to improve the heat absorption effect. The same components as those of the first and second embodiments will not be described again.

The battery pack 1c of the present embodiment and the battery-equipped device using the battery pack 1c can quickly guide the gas, if emitted from the battery 3, out of the battery pack 1c, and can cool the gas while guiding the gas. Therefore, the battery pack 1c is safer, and offers the same advantages as those of the first embodiment.

### Fifth Embodiment

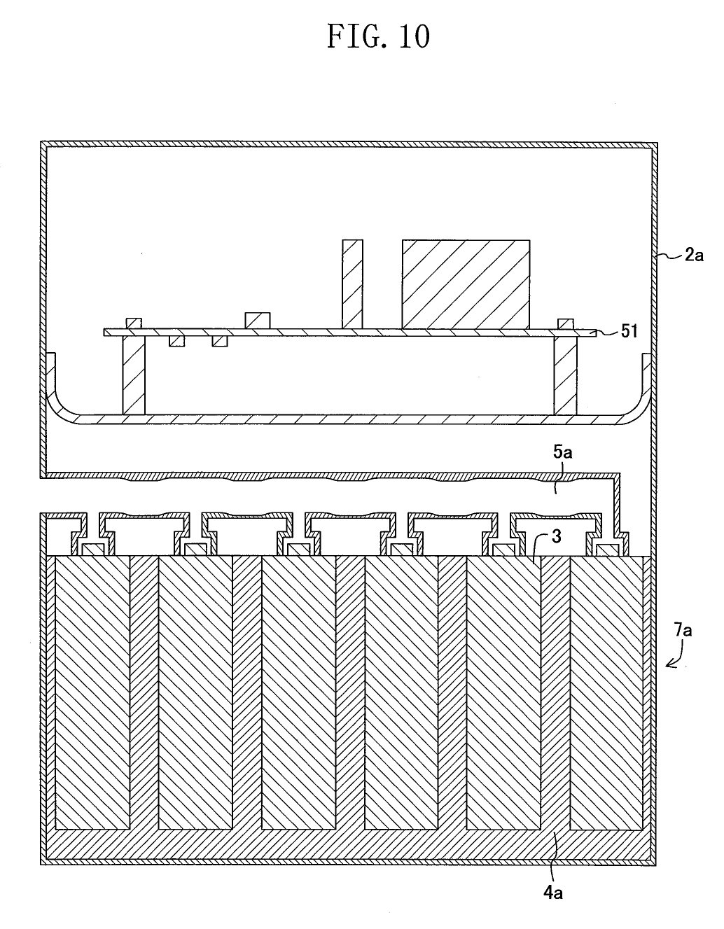

A battery-equipped device of a fifth embodiment is an uninterruptible power supply (UPS) including a plurality of batteries 3, and a circuit board 51 shown in FIG. 10. A casing of a battery pack is included in a casing 2a of the battery-equipped device. The casing 2a of the battery-equipped device is made of metal such as copper, aluminum, stainless steel, etc. A heat absorbing member 4a is provided around the batteries 3, and a battery containing chamber 7a and an exhaust path 5a are provided inside the casing 2a. The exhaust path 5a may be made of metal such as copper, aluminum, stainless steel, etc. With this configuration, even if one of the batteries 3 generates heat due to an internal short circuit or overcharge to cause thermal runaway, and high temperature gas is emitted from the inside of the battery 3, the heat generated by the battery is absorbed by the casing 2a of the battery-equipped device, the heat absorbing member 4a, and the exhaust path 5a, thereby preventing the thermal runaway from occurring in the other batteries 3. This can prevent thermal damage to the battery-equipped device, and can prevent damage caused by the emitted gas. The same components as those of the first to fourth embodiments will not be described again.

The battery pack and the battery-equipped device of the present embodiment offer the same advantages as those of the fourth embodiment.

### Other Embodiments

The above-described embodiments are provided only for illustrative purposes, and the invention is not limited to the embodiments. For example, as shown in FIG. 6, the batteries 3 may be arranged not in line, but may be arranged in several lines in the casing 2e, and a heat absorbing member 4e may be provided in wiring space between the lines.

While an example of the battery pack has been described in which the cylindrical batteries are contained in the casing, the batteries are not limited to the cylindrical ones, and only a single battery may be contained in the casing.

When nonflammable liquid or gas is used as the heat absorbing member, a heat conductive container, e.g., an aluminum foil bag, containing the liquid or gas may be used as the heat absorber. When a liquid material is used as the heat absorbing member, the liquid material may be gelled by mixing with, for example, a polymer material, and may be injected in the casing.

The heat absorbing member is not necessarily provided separately from the casing. For example, the heat absorbing member may be incorporated in the casing material. Thus, the casing itself also functions as the heat absorbing member, thereby absorbing the heat generated by the battery, and preventing damage to the battery pack.

The battery pack is not necessarily mounted in the battery-equipped device. A containing chamber for directly containing a plurality of cells may be provided in the battery-equipped device, and the heat absorbing member may be arranged in space inside the chamber.

In the fourth and fifth embodiments, the heat absorbing member 4a may be removed, and only the exhaust paths 5, 5a may be used as the heat absorber.

Since the heat absorbing member 4 used as a barrier between the batteries 3 is used as part of the exhaust path, the same advantages are obtained when the heat absorbing member 4 are arranged around the circumference of the battery 3. For example, the flat heat absorbing member 4 may be arranged in the interval t between the batteries 3, or may be wound on the surface of each of the batteries 3.

An alternative of the battery pack, and a device equipped with the battery pack will be described below.

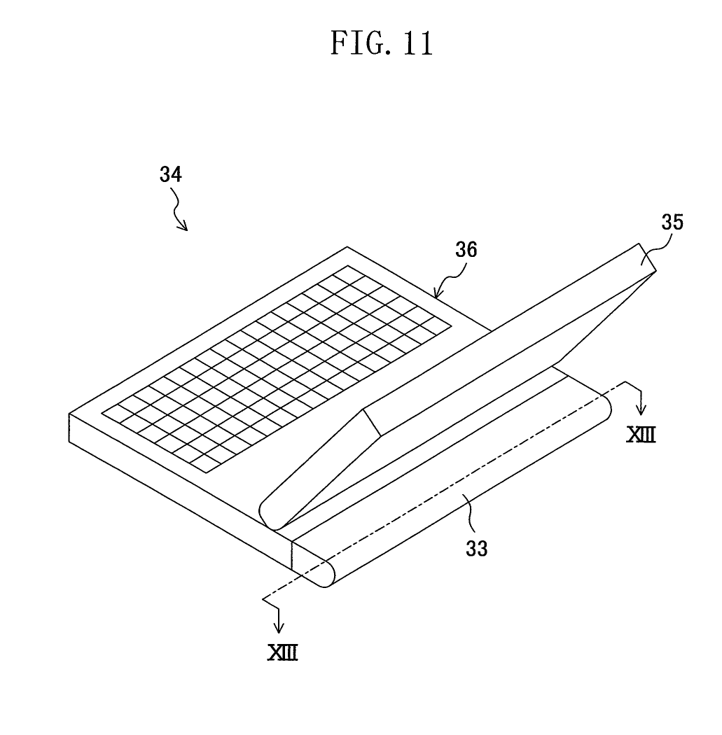

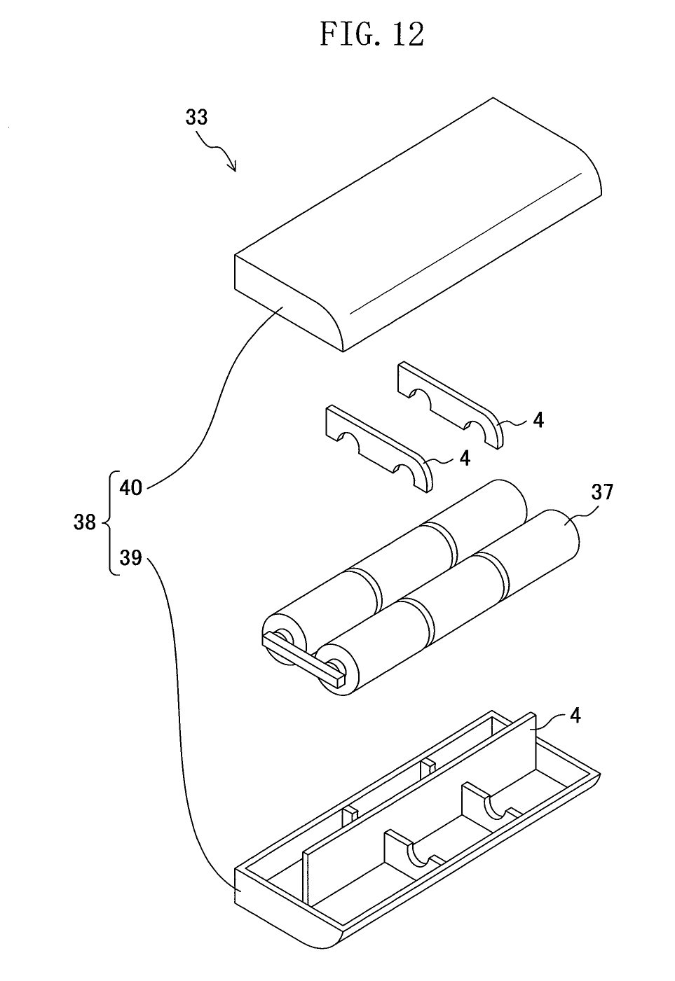

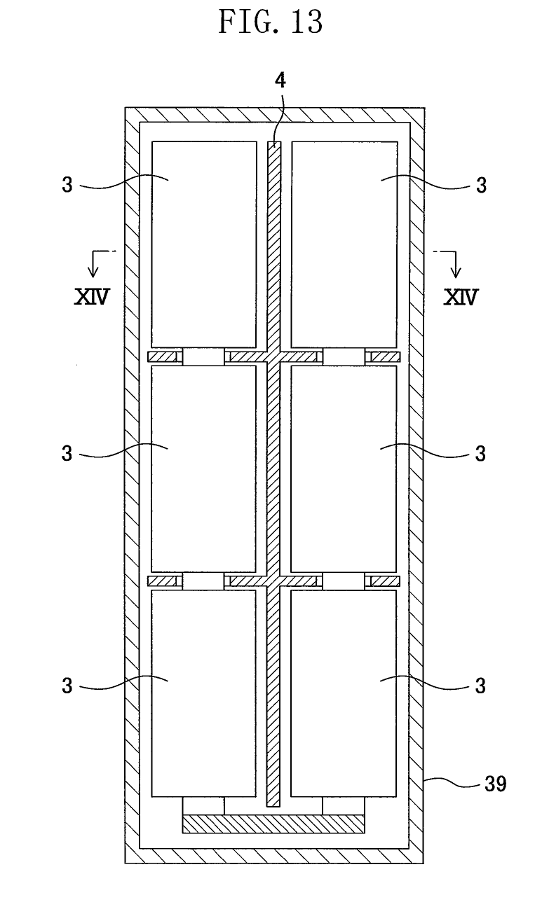

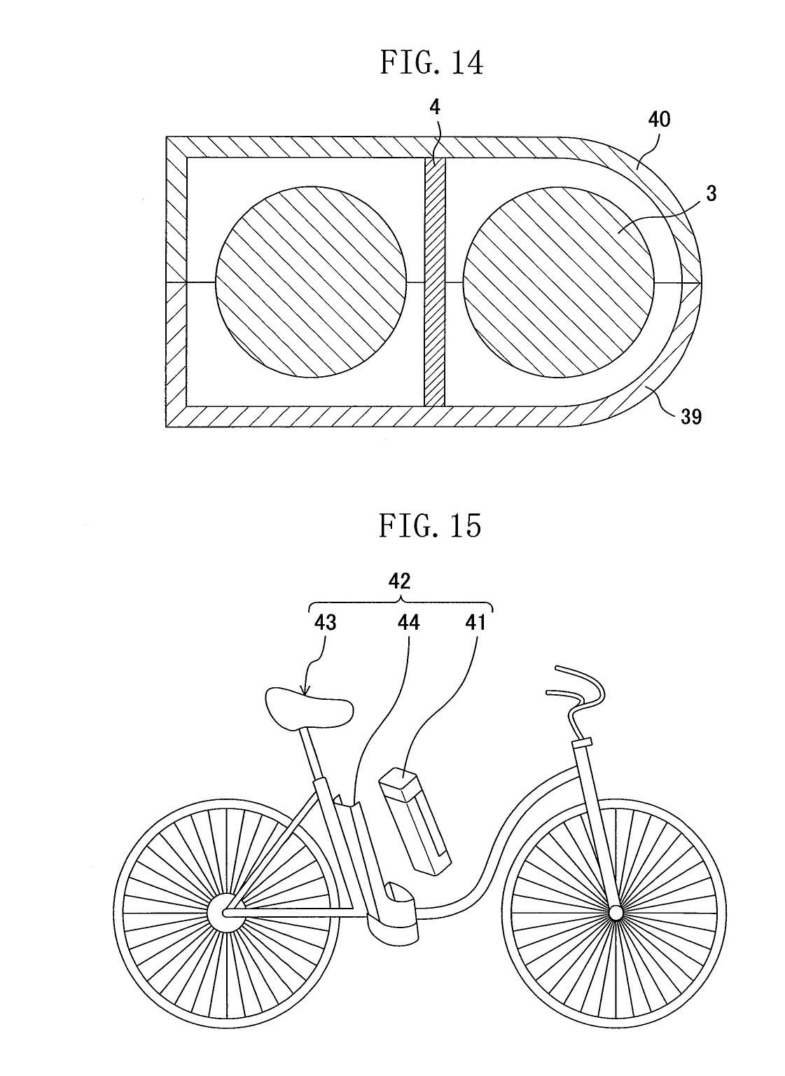

FIG. 11 is a perspective view illustrating the general structure of a notebook computer 34 equipped with a battery pack 33. FIG. 12 is a perspective view of the battery pack 33 of FIG. 11 in a disassembled state. FIG. 13 is a cross-sectional view taken along the line XIII-XIII in FIG. 11, and FIG. 14 is a cross-sectional view taken along the line XIV-XIV in FIG. 13.

As shown in the drawings, the notebook computer 34 includes a computer body 36 including a display 35, and a battery pack 33 mounted in a rear portion of the computer body 36.

The battery pack 33 includes a battery assembly 37 including six batteries 3, a heat absorbing member 4 for absorbing heat of gas emitted from each battery 3 in an abnormal situation, and a casing 38 including a battery container 39 for containing the battery assembly 37 and the heat absorbing member 4, and a battery pack lid 40.

The heat absorbing member 4 is arranged in a gap between the battery assembly 37 and the casing 38 to be in contact with the batteries 3.

Even if the battery 3 in the battery pack 33 generates heat due to an internal short circuit or overcharge, and the gas is blown out of the battery 3, the heat absorbing member 4 absorbs the heat generated by the battery, thereby preventing thermal runaway in the other batteries 3. This can prevent thermal damage to the battery pack and the battery-equipped device, and can prevent damage caused by the emitted gas.

Another alternative of the battery pack, and an electric power-assisted bicycle equipped with the battery pack will be described below.

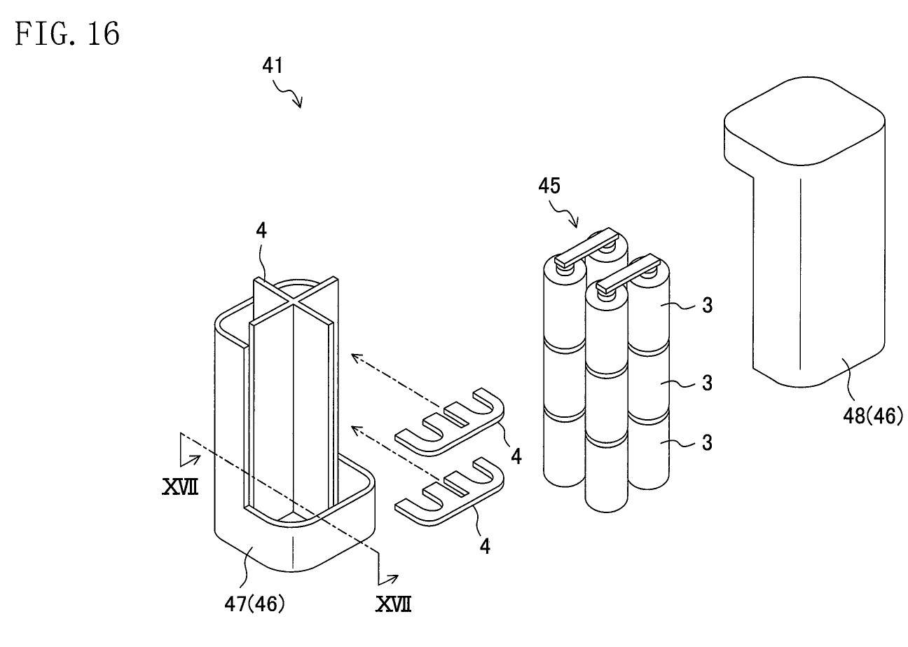

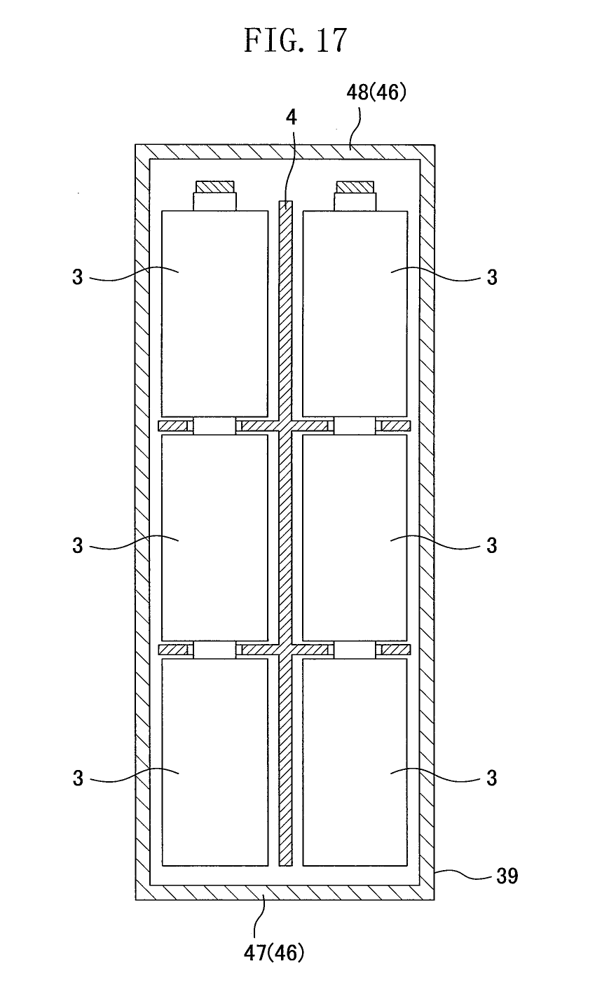

FIG. 15 is a side view illustrating the general structure of an electric bicycle 42 equipped with a battery pack 41. FIG. 16 is a perspective view of the battery pack 41 of FIG. 15 in a disassembled state. FIG. 17 is a cross-sectional view taken along the line XVII-XVII in FIG. 16.

As shown in the drawings, the electric bicycle 42 includes a bicycle body 43, a holder 44 provided on the bicycle body 43, and a battery pack 41 attached to the holder 44. An unshown motor is driven by power of the battery pack 41.

The battery pack 41 includes a battery assembly 45 including twelve batteries 3, a heat absorbing member 4 for absorbing heat of gas emitted from each battery 3 in an abnormal situation, and a casing 46 including a battery container 47 for containing the battery assembly 45 and the heat absorbing member 4, and a battery pack lid.

In the battery assembly 45, four sets of three series-connected batteries 3 are connected in parallel (FIG. 17 shows two of the sets connected in parallel).

Even if the battery 3 in the battery pack 41 generates heat due to an internal short circuit or overcharge, and the gas is blown out of the battery 3, the heat absorbing member 4 absorbs the heat generated by the battery, thereby preventing thermal runaway in the other batteries 3. This can prevent thermal damage to the battery pack and the battery-equipped device, and can prevent damage caused by the emitted gas.

Still another alternative of the battery pack, and a hybrid automobile equipped with the battery pack will be described below.

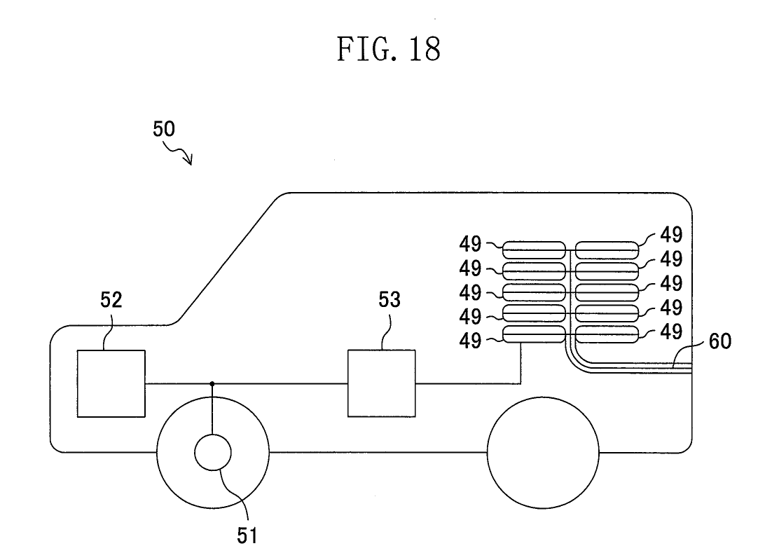

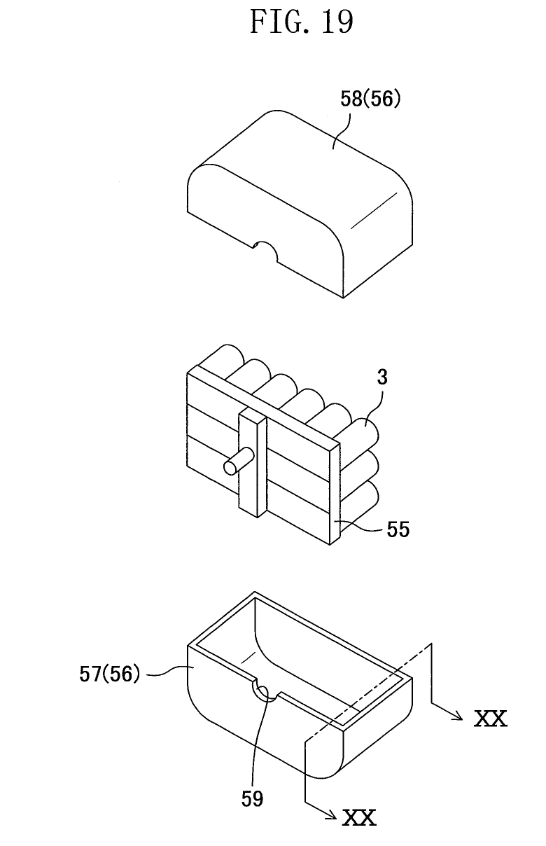

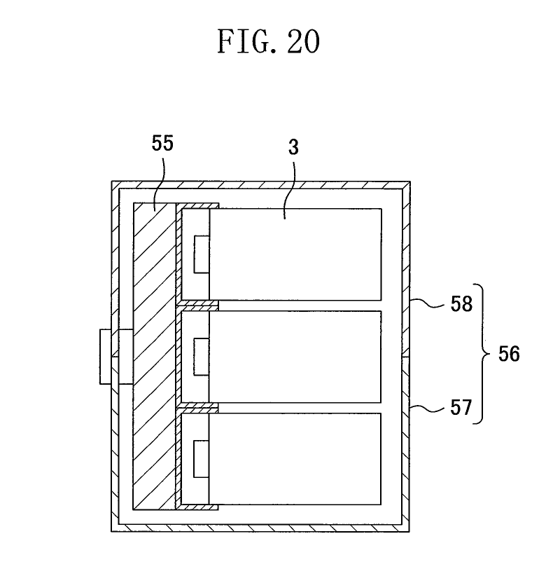

FIG. 18 is a side view illustrating the general structure of a hybrid automobile 50 equipped with a battery pack 49. FIG. 19 is a perspective view of the battery pack 49 of FIG. 18 in a disassembled state. FIG. 20 is a cross-sectional view taken along the line XX-XX in FIG. 19.

The hybrid automobile 50 includes a plurality of battery packs 49, a motor 51 driven by power of the battery packs 49, an engine 52, and an axle 53 which is driven to rotate by power of the motor 51 or the engine 52. The hybrid automobile 50 is configured to charge the battery packs 49 by regenerating kinetic energy of braking etc., through the motor 51.

Each of the battery packs 49 includes a battery assembly 54 including eighteen batteries 3, a gas collecting member 55 for collecting gas emitted from each battery 3 in an abnormal situation, and a casing 56 including a battery container 57 for containing the battery assembly 54 and the gas collecting member 55, and a battery pack lid 58.

In the battery assembly 54, three sets of six series-connected batteries 3 are connected in series.

As shown in FIG. 19, in each of the battery packs 49, the gas collecting member 55 is attached to the sealed portions of the batteries 3 to cover the electrode openings 30 of the batteries 3, and an exhaust path 60 connecting the gas collecting member 55 and an opening 59 is provided in the hybrid automobile 50. The exhaust path 60 also functions as a heat absorber for absorbing heat of the gas. Therefore, even if the gas is emitted from the battery 3 in an abnormal situation, the exhaust path 60 can quickly guide the gas outside the battery pack 49, while cooling the gas, thereby preventing thermal runaway in the other batteries 3. This can prevent thermal damage to the battery-equipped device, and can prevent damage caused by the emitted gas.

In FIGS. 11 to 20, examples of the notebook computer, the electric bicycle, and the hybrid automobile have been described. However, the device equipped with the battery pack may be electrically powered devices and electronic devices, such as cellular phones and audio players using a single battery, and digital still cameras, electric tools, etc., using a plurality of batteries.

According to the embodiments described above, even if the battery 3 generates heat due to the internal short circuit or overcharge, and experiences the thermal runaway in which the high temperature gas is emitted from the inside of the battery 3, the heat absorbing member 4 absorbs the heat generated by the battery 3. This can prevent thermal damage to the battery pack, and can prevent spontaneous ignition and combustion of the emitted gas. Thus, damage to the battery pack 1 can be prevented.

### EXAMPLES

The battery 3 shown in FIG. 3 was produced in the following manner. Specifically, an aluminum foil current collector carrying a positive electrode material mixture was used as the positive electrode 17, and a copper foil current collector carrying a negative electrode material mixture was used as the negative electrode 19. The separator 21 was 25 μm in thickness. The positive current collector lead 18 and the aluminum foil current collector were laser-welded. The negative current collector lead 20 and the copper foil current collector were resistance-welded. The negative current collector lead 20 was electrically connected to a bottom of the metallic, closed-end case 24 by resistance welding. The positive current collector lead 18 is electrically connected to a metallic filter of the sealing plate 26 having a safety valve by laser welding from an opening end of the case 24. Then, a nonaqueous electrolyte was injected through an opening end of the case 24. A groove is formed in the opening end of the case 24 to form a seat. The positive current collector lead 18 is folded, a resin outer gasket 25 and the sealing plate 26 are attached to the seat of the case 24, and the whole opening end of the case 24 was crimped to seal the battery.

Details will be described below.

### (1) Production of Positive Electrode 17

The positive electrode 17 was produced in the following manner. 85 parts by weight of lithium cobaltate powder as the positive electrode material mixture, 10 parts by weight of carbon powder as a conductive agent, and a solution of polyvinylidene fluoride (hereinafter abbreviated as PVDF) in N-methyl-2-pyrrolidone (hereinafter abbreviated as NMP) as a binder were mixed in such a manner that 5 parts by weight of PVDF was contained in the resulting mixture. The mixture was applied to a 15 μm thick aluminum foil current collector, dried, and rolled, thereby obtaining a 100 μm thick positive electrode 17.

### (2) Production of Negative Electrode 19

The negative electrode 19 was produced in the following manner. 95 parts by weight of artificial graphite powder as the negative electrode material mixture, and a PVDF in NMP solution as a binder were mixed in such a manner that 5 parts by weight of PVDF was contained in the resulting mixture. The mixture was applied to a 10 μm thick copper foil current collector, dried, and rolled, thereby obtaining a 110 μm thick negative electrode 19.

### (3) Preparation of Nonaqueous Electrolyte

The nonaqueous electrolyte was prepared in the following manner. Ethylene carbonate and ethylmethyl carbonate were mixed in a volume ratio of 1:1 as a nonaqueous solvent, and lithium hexafluorophosphate (LiPF₆) was dissolved as a solute in the solvent to 1 mol/L. 15 ml of the prepared nonaqueous electrolyte was used.

### (4) Production of Hermetic Secondary Battery 3

The positive electrode 17 and the negative electrode 19 were wound with the 25 μm thick separator 21 interposed between to provide a cylindrical electrode group 28. Then, the obtained electrode group was inserted in the metallic, closed-end case 24, the nonaqueous electrolyte was injected in the case, and the case was sealed to obtain a hermetic nonaqueous electrolyte secondary battery 3. The battery was a cylindrical battery with a 25 mm diameter, and a 65 mm height, and had a designed capacity of 2000 mAh. A 80 μm thick, polyethylene terephthalate heat shrinkable tubing as a battery case insulator 13 was applied to the obtained battery 3 to cover the entire surface of the battery up to the edge of the top face, and the tubing was heat-shrunk by hot air at 90° C. Thus, the battery was finished.

### (5) Production of Battery Assembly 11

Six cylindrical lithium ion secondary batteries 3 produced as described above were arranged as shown in FIG. 4, and were series-connected through 0.2 mm thick nickel connector plates 12. Further, connector lead wires 14 for conduction between the series-connected batteries 3 and a battery pack terminal 10 were attached to the batteries 3. Thus, the battery assembly 11 was obtained. The battery assembly 11 was contained in the battery container 7, and the heat absorbing member of any one of examples 1 to 5 was arranged, and the battery pack lid 8 was welded to the rim of the battery container 7. The battery container 7 and the battery pack lid 8 were made of stainless steel, and a thickness thereof was 0.5 mm at the minimum.

### Example 1

The battery pack 1 shown in FIGS. 1 and 2 was produced using Fire Barrier manufactured by Sumitomo 3M as the heat absorbing member 4.

### Example 2

A battery pack of Example 2 was produced in which the batteries 3 were arranged as shown in FIG. 5 with an interval t of 5 mm provided therebetween, and a ceramic plate was arranged as the heat absorbing member 4b between the adjacent batteries 3.

### Example 3

A battery pack of Example 3 was produced in which the batteries 3 were arranged as shown in FIG. 5 with an interval t of 5 mm provided therebetween, and a sealed aluminum foil bag filled with water was arranged as the heat absorbing member 4 between the adjacent batteries 3.

### Example 4

A battery pack of Example 4 was produced in which the batteries 3 were arranged as shown in FIG. 5 with an interval t of 5 mm provided therebetween, and Heat Buster TK2 manufactured by PDM was injected as the heat absorbing member 4 to fill space between the adjacent batteries 3.

### Example 5

The batteries 3 were arranged as shown in FIG. 8 with an interval t of 5 mm provided therebetween, and the copper gas collecting member 16 and the exhaust path 5 were provided to guide the gas to be emitted through the electrode opening 30 of the battery 3.

### Comparative Example 1

The heat absorbing member 4 was removed from the structure shown in FIG. 2, i.e., the adjacent batteries were arranged to be in contact with each other, and space inside the casing (space between the casing and the batteries) was filled with air. The opening of the casing of the battery pack was left exposed outside.

The battery packs of Examples and Comparative Example were examined in the following manner.

### (6) Nail Penetration Test

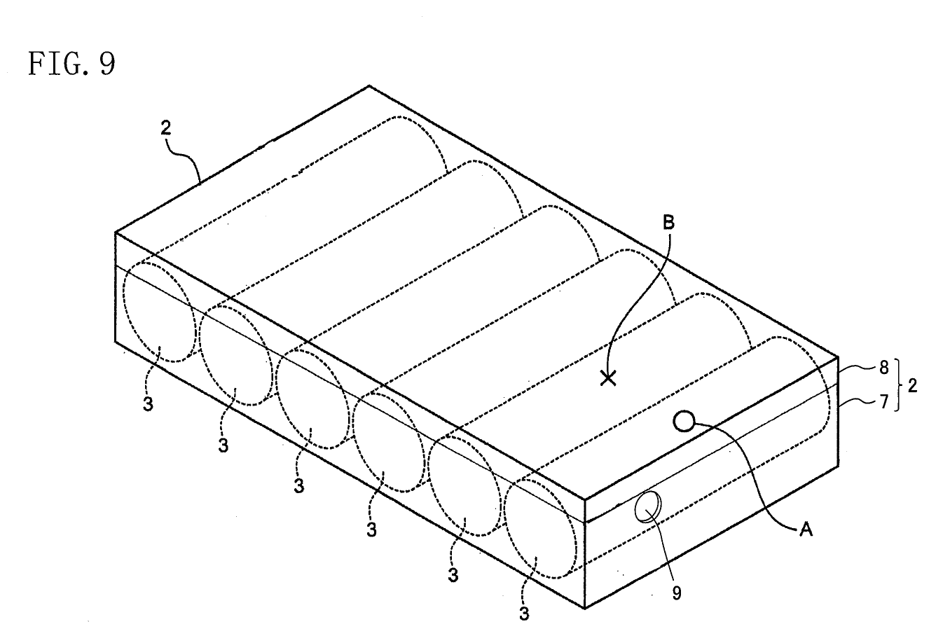

Each of the finished battery packs was charged to 25.2 V. Then, at a temperature of 20° C., a 2 mm diameter iron nail was inserted in a through hole A provided in advance in the battery pack lid 8 shown in FIG. 9 to penetrate a first battery 3 in the battery pack, while passing through a center in the height direction and a center in the radial direction of the battery 3 at a speed of 5 mm/sec, thereby causing the thermal runaway in the battery 3. To examine how the other batteries 3 were affected by the high temperature gas emitted from the penetrated battery 3, temperature of the surface of the second battery 3 adjacent to the penetrated battery was measured at point B. After the battery pack was left stand for 10 minutes, whether or not the thermal runaway occurred in the batteries except for the penetrated battery in the battery pack was checked. Table 1 shows the results. The surface temperature of the second battery designates a maximum temperature (a peak temperature) after the nail penetration. Before and after the temperature reached the maximum, the temperature greatly varied within a short time. The peak temperature was observed only for a short time.

TABLE 1

| | Surface temperature | |
|---|---|---|
| | of the second battery | Effect on the other batteries |
| Example 1 | 198° C. | No thermal runaway occurred |
| Example 2 | 287° C. | No thermal runaway occurred |
| Example 3 | 150° C. | No thermal runaway occurred |
| Example 4 | 147° C. | No thermal runaway occurred |
| Example 5 | 273° C. | No thermal runaway occurred |
| Comparative | 666° C. | Thermal runaway occurred in |
| Example 1 | | every battery |

As shown in Table 1, thermal effect on the other batteries in the battery pack can considerably be reduced by reducing heat of the gas blown out of the battery in any way. This is due to the heat absorber which absorbs the heat generated by the battery, and the heat of the high temperature emitted gas. By contrast, in the battery pack without any measures to reduce the heat (Comparative Example 1), the heat generated by the battery was directly transmitted to the adjacent battery, and the high temperature emitted gas directly came into contact with the outer surface of the adjacent battery, thereby causing an abnormal event (thermal runaway). Thus, absorbing the heat generated by the battery, and the heat of the high temperature emitted gas makes it possible to prevent the battery pack from break and burning, and to prevent an abnormal event from occurring in the other batteries in the battery pack.

### INDUSTRIAL APPLICABILITY

As described above, according to the battery pack of the present invention, even if an abnormal event occurs in the battery in the battery pack, and the battery generates heat and emits high temperature gas, break of the battery pack can be prevented, and an abnormal event in the other batteries in the battery pack can be prevented. Thus, the battery pack of the present invention is useful as a battery pack for a battery-equipped device, such as computers and cellular phones.

### DESCRIPTION OF REFERENCE CHARACTERS

1, 33, 41, 49 Battery pack
1a Battery pack
1b Battery pack
1c Battery pack
2, 38, 46, 56 Casing
2a Casing of battery-equipped device
2e Casing
3 Battery (cell)
4 Heat absorbing member (heat absorber)
4a Heat absorbing member (heat absorber)
4b Heat absorbing member (heat absorber)
4e Heat absorbing member (heat absorber)
5, 60 Exhaust path
6 Space
7, 39, 47, 57 Battery container
7a Battery containing chamber
8, 40, 48, 58 Battery pack lid
9, 59 Opening
10 Battery pack terminal
11, 37, 45, 54 Battery assembly
12 Connector plate
13 Battery case insulator
14 Connector lead wire
15 Protrusion
16, 55 Gas collecting member
17 Positive electrode
18 Positive current collector lead
19 Negative electrode
20 Negative current collector lead
21 Separator
22 Upper insulator
23 Lower insulator
24 Case
25 Gasket
26 Sealing plate
27 Positive electrode terminal
28 Electrode group
29 Groove
30 Electrode opening (emission hole)
34 Notebook computer
35 Display
36 Computer body
42 Electric bicycle
43 Bicycle body
44 Holder
50 Electric automobile
51 Motor
52 Engine
53 Axle

1. A battery pack comprising:
a plurality of cells;
a casing for containing the cells; and
a heat absorber for absorbing heat generated by the cells, wherein
the cells are lithium ion batteries, and
the heat absorber absorbs heat of gas generated from the inside of one of the cells which experienced thermal runaway so as to keep temperature of the gas at 300° C. or lower, thereby preventing the thermal runaway from occurring in the other cells adjacent to the cell which experienced the thermal runaway.

2. The battery pack of claim 1, wherein
the heat absorber is placed inside the casing.

3. The battery pack of claim 2, wherein
the heat absorber is made of a material having a specific heat of 0.5 J/g·K or higher.

4. The battery pack of claim 1, wherein
the casing is made of a material having a specific heat of 0.5 J/g·K or higher.

5. The battery pack of claim 1, further comprising:
an exhaust path for guiding the gas outside the casing, wherein
the gas is emitted through an emission hole provided in the cell.

6. A battery-equipped device comprising the battery pack of claim 1.

7. A battery-equipped device comprising:
a plurality of cells;
a containing chamber for containing the cells; and
a heat absorber for absorbing heat generated by the cells, wherein
the cells are lithium ion batteries, and
the heat absorber absorbs heat of gas generated from the inside of one of the cells which experienced thermal runaway so as to keep temperature of the gas at 300° C. or lower, thereby preventing the thermal runaway from occurring in the other cells adjacent to the cell which experienced the thermal runaway.

8. The battery-equipped device of claim 7, further comprising:
an exhaust path for guiding the gas outside the casing, wherein
the gas is emitted through an emission hole provided in the cell.

9. The battery pack of claim 5, wherein
a wall of the exhaust path comprises at least part of the heat absorber.

10. A battery-equipped device comprising the battery pack of claim 9.

11. The battery-equipped device of claim 8, wherein
a wall of the exhaust path comprises at least part of the heat absorber.
